(19) United States
(12) Patent Application Publication
(10) Pub. No.: US 2015/0043521 A1
(43) Pub. Date: Feb. 12, 2015

(54) METHOD FOR MAPPING HYBRID ARQ INDICATOR CHANNEL

(71) Applicant: Pantech Co., Ltd., Seoul (KR)

(72) Inventors: Dong Hyun Park, Seoul (KR); Sung Jun Yoon, Seoul (KR)

(73) Assignee: Pantech Co., Ltd., Seoul (KR)

(21) Appl. No.: 14/374,857

(22) PCT Filed: Jan. 30, 2013
(86) PCT No.: PCT/KR2013/000748

§ 371 Date: Jul. 25, 2014

(30) Foreign Application Priority Data
Jan. 30, 2012 (KR) 10-2012-0009283

(51) Int. Cl. H04L 5/00; H04L 1/18

(52) U.S. Cl. CPC H04L 5/0037; H04L 1/18
USPC 370/330

(57) ABSTRACT

The present invention relates to a method for mapping a hybrid ARQ indicator channel, which is transmitted to a downlink in a wireless communication system, to a frequency and a time resource.

### CROSS-REFERENCE TO RELATED APPLICATIONS

This application is the National Stage Entry of International Application PCT/KR2013/000748, filed on Jan. 30, 2013, and claims priority from and the benefit of Korean Patent Application No. 10-2012-0009283, filed on Jan. 30, 2012, each of which is hereby incorporated by reference for all purposes as if fully set forth herein.

### BACKGROUND

1. Field

The present invention relates to a method of mapping a hybrid ARQ indication channel, transmitted in a downlink in a wireless communication system, to frequency and time resources.

2. Discussion of the Background

When a packet is transmitted and received in a mobile communication system, a receiver needs to report, to a transmitter, whether or not the reception of a packet is successful. When the reception of a packet is successful, the receiver transmits an acknowledgement (ACK) so that the transmitter transmits a new packet, and when the packet is not received, the receiver transmits a Negative Acknowledgement (NACK) so that the transmitter retransmits the packet. This operation is referred to as an Automatic Repeat (ARQ). A Hybrid ARQ (HARQ) has been provided by coupling the ARQ operation and a channel coding scheme. Information associated with the HARQ may be transmitted through a Physical HARQ Indication Channel (PHICH) set in a control area.

As new communication schemes have developed, there have been occasional cases where a control area is not set or resources of a control area are insufficient. For this case, resources for transmitting control information may be set in a data area through which data is transmitted, and the control information may be transmitted based on the set resources. However, transmission of information associated with the HARQ, based on control information transmission resources set in the data area, has not been considered.

### SUMMARY

Therefore, the present invention has been made in view of the above-mentioned problems, and an aspect of the present invention is to provide a method of mapping HARQ information to a control information transmission resource set in a data area and transmitting the HARQ information through the data.

In accordance with an aspect of the present invention, there is provided a method of mapping a hybrid Automatic Repeat reQuest (ARQ) indication channel based on a resource is element unit, the method including: setting, in a data area through which downlink data is transmitted, resource blocks where an Enhanced Physical Downlink Control CHannel (E-PDCCH) is set; determining an index of a resource element group through which the hybrid ARQ indication channel is transmitted, based on the total number of available resource element groups of an E-PDCCH in the set resource blocks; and mapping the hybrid ARQ indication channel to a resource element, based on the determined index.

The resource element group is located in a predetermined OFDM symbol.

In this instance, when a plurality of OFDM symbols, where the resource element group is located, exists, and the number of resource element groups located in each OFDM symbol is different from each other, the index of the resource element group may be determined based on a ratio of the number of resource element groups available in a symbol in which the hybrid ARQ indication channel is transmitted and the number of resource element groups available in a symbol in which a first resource element group is transmitted.

Determining the index determines the index of the resource element group based on the following equation:

$${\overline{n}}_{i} = \{ \begin{matrix}( ⌊ {N}_{ID}^{cell} \cdot {n}_{{l}_{i}^{′}} / {n}_{{l}_{0 i}^{′}} ⌋ + {m}^{′} ) mod {n}_{{l}_{i}^{′}} & i = 0 \\ ( ⌊ {N}_{ID}^{cell} \cdot {n}_{{l}_{i}^{′}} / {n}_{{l}_{0 i}^{′}} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{cell} \cdot {n}_{{l}_{i}^{′}} / {n}_{{l}_{0 i}^{′}} ⌋ + {m}^{′} + ⌊ 2 {n}_{{l}_{i}^{′}} / 3 ⌋ ) mod {n}_{{l}_{i}^{′}} & i = 2\end{matrix} ,$$

wherein n̅ᵢ denotes an index of a resource element group through which a hybrid ARQ indication channel is transmitted, N_{ID}^{cell} denotes a cell ID, m′ denotes an index of a hybrid ARQ indication channel group, and n_{l′}_{ᵢ} denotes the number of REGs usable for E-PHICH transmission in an OFDM symbol l′ᵢ, which is obtained through a product of the number of resource blocks to which E-PDCCH is set and 2 or 3.

Alternatively, the resource element group is located in an entire extended control is channel, excluding a resource to which a reference signal is set.

In this instance, determining the index determines the index of the resource element group based on the following Equation:

$${\overline{n}}_{i} = \{ \begin{matrix}{n}^{′} mod {N}_{E - PHICH}^{REG} & i = 0 \\ ( {n}^{′} + ⌊ {N}_{E - PHICH}^{REG} / 3 ⌋ ) mod {N}_{E - PHICH}^{REG} & i = 1 \\ ( {n}^{′} + 2 \cdot ⌊ {N}_{E - PHICH}^{REG} / 3 ⌋ ) mod {N}_{E - PHICH}^{REG} & i = 2\end{matrix} \\ {n}^{′} = {N}_{ID}^{cell} + n ,$$

wherein n̅ᵢ denotes an index of a resource element group through which a hybrid ARQ indication channel is transmitted, N_{E-PHICH}^{REG} the total number of available resource element groups, N_{ID}^{cell} denotes a cell ID, and n denotes an index of a hybrid ARQ indication channel group.

An index of each resource element group included in an identical hybrid ARQ indication channel group is distributed, being spaced apart at regular intervals.

An index of each resource element group included in an identical hybrid ARQ indication channel group is contiguously distributed.

According to the present invention, HARQ information is mapped to a control information transmission resource set in a data area, and the HARQ information is transmitted through the data area.

### BRIEF DESCRIPTION OF THE DRAWINGS

FIG. 1 illustrates a wireless communication system according to embodiments of the present invention;

FIG. 2 is a diagram illustrating a PHICH processing process in a base station;

FIG. 3 illustrates a pair of resource blocks to which distributed mapping is applied;

FIG. 4 illustrates a pair of resource blocks to which localized mapping is applied;

FIG. 5 illustrates a single pair of resource blocks in a normal CP;

FIG. 6 illustrates a single pair of resource blocks in an extended CP;

FIG. 7 is a diagram illustrating to which REG of which pair of resource blocks an E-PHICH is mapped;

FIGS. 8 and 9 are diagrams illustrating a method of determining an REG index in a normal CP;

FIG. 10 illustrates a case in which three OFDM symbols are used for E-PHICH transmission in a normal CP;

FIG. 11 illustrates a case in which 9 pairs of resource blocks are used as distributed control areas, and 27 available REGs exist in a single pair of resource blocks;

FIGS. 12 and 13 are diagrams illustrating numbering of REGs in a pair of physical resource blocks; and

FIGS. 14 and 15 illustrate a localized mapping method.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

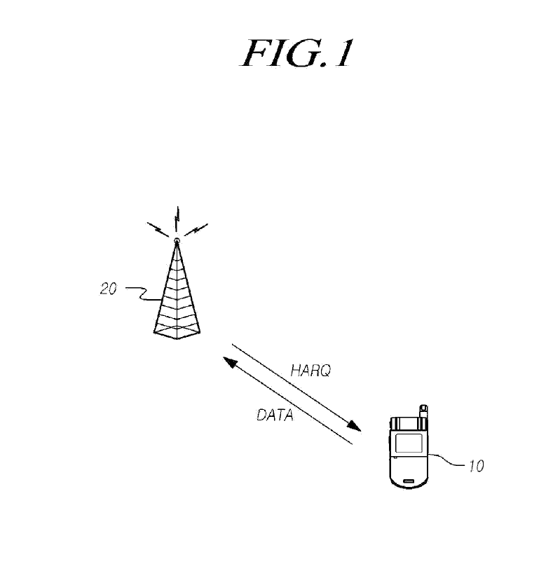

FIG. 1 illustrates a wireless communication system according to embodiments of the present invention.

The wireless communication system may be widely installed so as to provide various communication services, such as a voice service, packet data, and the like.

Referring to FIG. 1, a wireless communication system may include a User Equipment (UE) 10 and a base station 20 that executes uplink and downlink communication with the user equipment 10.

The user equipment 10 may transmit, to the base station 20, uplink data through a Physical Uplink Shared Channel (PUSCH), and the base station 20 transmits an HARQ response with respect to the uplink data transmission of the user equipment 10 through a Physical HARQ Indicator Channel (PHICH).

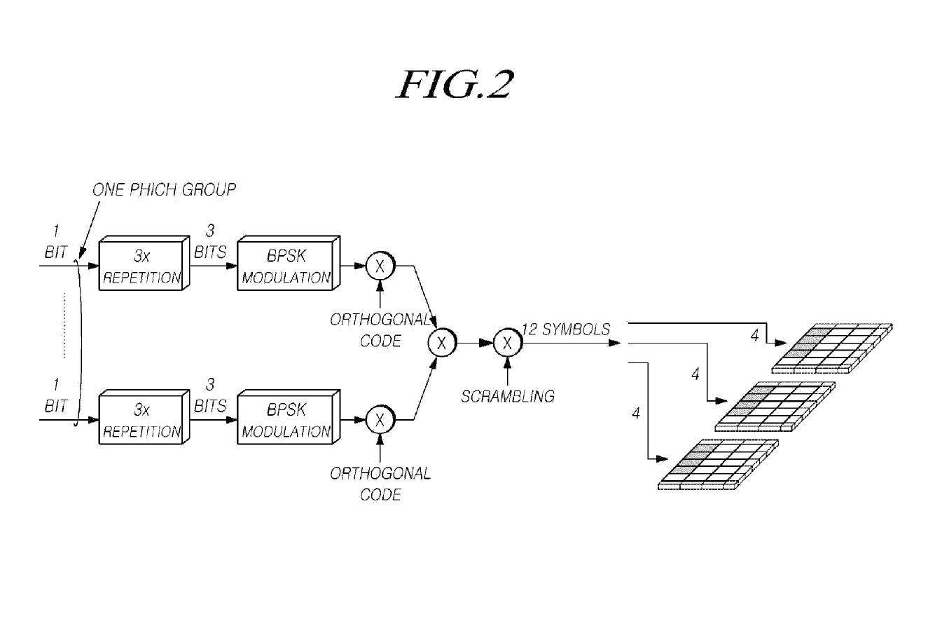

FIG. 2 is a diagram illustrating a PHICH processing process in the base station 20.

Referring to FIG. 2, 1 bit information of HARQ A/N is repeated (repetition) three is times, is BiPhase Shift Keying (BPSK)-modulated based on I axis or Q axis, and is spread as an orthogonal sequence having a length of 4. PHICHs transmitted through a set of identical Resource Elements (REs) are referred to as a PHICH group. In the case of a normal Cyclic Prefix (CP), 8 PHICHs form a single PHICH group. In the case of an extended CP, an orthogonal sequence having a length of 2 is used, and 4 PHICHs form a single PHICH group.

PHICHs are configured to be a complex form in a single PHICH group, and the signal is scrambled and then scrambled symbols are mapped to three resource element Group (REG). Each REG is formed of 4 REs. To obtain an excellent frequency diversity gain, each REG is located, being spaced apart at intervals of ⅓ of a downlink cell bandwidth.

A PHICH is transmitted in 1 through 3 Orthogonal Frequency Division Multiplexing (OFDM) symbols. When a PHICH is transmitted in a single OFDM symbol, three REGs to which a PHICH is mapped are located in a single OFDM. When a PHICH is transmitted in two OFDM symbols, two REGs are located in a single OFDM symbol, and a single REG is located in the other OFDM symbol. When a PHICH is transmitted in three OFDM symbols, a single REG is located in each OFDM symbol.

A PHICH may be set in a control area formed of 1 through 4 OFDM symbols in a single subframe. The control area may include control channels, such as a Physical Control Format Indicator Channel (PCFICH), a Physical Downlink Control Channel (PDCCH), and the like, in addition to the PHICH. From the resources of the control area, a resource for the PCFICH is allocated first, a resource for the PHICH is allocated, and then, a resource for the PDCCH is allocated. The PCFICH, the PHICH, the PDCCH, and the like may be modulated using a Cell-specific Reference Signal (CRS) as a reference signal.

Meanwhile, a new channel for transmission of a PHICH may be required, in is addition to the PHICH allocated to the control area.

(1) a carrier that does not have a control area, or a carrier that does not have a CRS, may be considered in a downlink. In this case, a new channel may be required for PHICH transmission.

(2) Decoding a PHICH may be required using a reference signal which is different from a CRS, to improve a transmission environment using beamforming, Spatial Multiplexing (SM), and an frequency domain Inter Cell Interference Coordination (ICIC).

(3) When a plurality of transmission ends (for example, a single broadband base station and one or more Radio Resource Heads (RRHs)) have an identical cell ID and cooperate for communication, as shown in Coordinated Multi-Point (CoMP) scenario 4, the limited PHICH resources may act as bottleneck when the plurality of transmitting ends cooperate for communication and may limit the cooperate communication.

(4) In the case of uplink Semi-Persistent Scheduling (SPS), the probability of a PHICH resource conflict may increase. To avoid the above, additional UL grant scheduling limit may be caused.

Due to the above described reasons, a resource for transmitting control information may be allocated to a data area, as opposed to a control area, and a channel for HARQ transmission with respect to uplink transmission corresponding to a PHICH and/or a channel for transmission of downlink control information corresponding to a PDCCH may be set in the resource.

In the present specification, a channel allocated to the data area for transmitting the control information is referred to as an Enhanced Control CHannel or an Extended Control Channel (E-CCH), a channel corresponding to a PHICH in the E-CCH is referred to as an is Enhanced PHICH or an Extended PHICH (E-PHICH), and a channel corresponding to a PDCCH is referred to as an Enhanced PDCCH or an Extended PDCCH (E-PDCCH). Alternatively, downlink control information corresponding to a PDCCH is mainly transmitted and thus, a channel allocated to the data area for transmitting the control information may be also referred to as an E-PDCCH. The above described names are for ease of description, and the present invention is not limited to the described names.

The E-PHICH and the E-PDCCH may be decoded using a Demodulation Reference Signal (DM-RS) (or also referred to as a UE-specific Reference Signal (UE-RS)).

In a pair of resource blocks, each of which is formed of a single subframe as a time axis and a frequency axis of 180 KHz (or 12 subcarriers), an E-CCH of the data area may be allocated to at least one user equipment, and the at least one user equipment may decode a channel for the user equipment using an identical DM-RS. Hereinafter, the above mentioned case is referred to as distributed mapping.

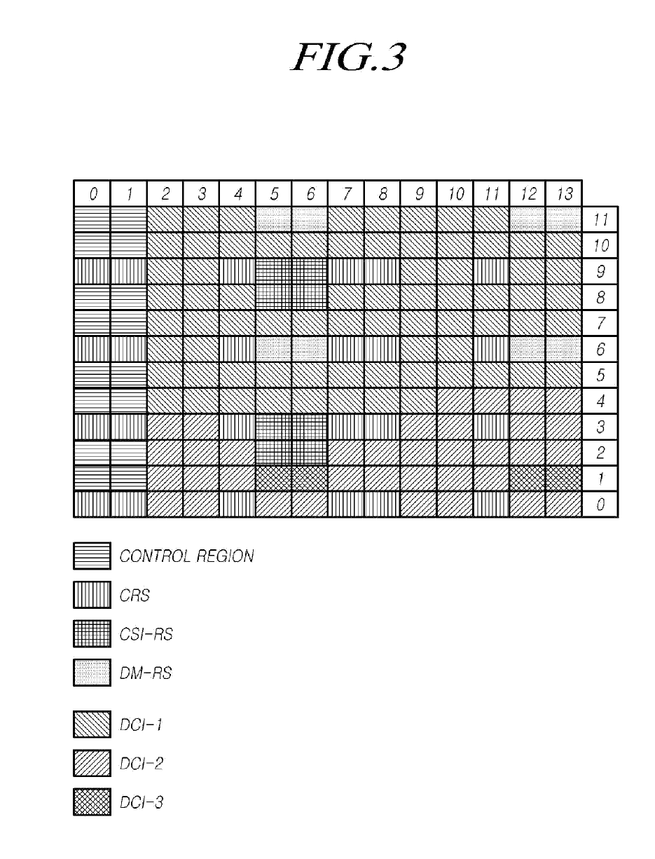

FIG. 3 illustrates a pair of resource blocks to which distributed mapping is applied. Referring to FIG. 3, a DCI (DCI-1) for user equipment 1, a DCI (DCI-2) for user equipment 2, and a DCI (DCI-3) for user equipment 3 are mapped to a data area (l=2˜11), and DM-RS resources may be modulated based on an identical scheme. Each user equipment (user equipments 1˜3) may demodulate an E-PDCCH using a DM-RS, and may extract downlink control information (DCI 1˜3) allocated to a corresponding user equipment.

Alternatively, an E-CCH is allocated for a plurality of user equipments, and the is plurality of user equipments may use different DM-RSs so as to decode corresponding channels. Hereinafter, the above mentioned case is referred to as localized mapping.

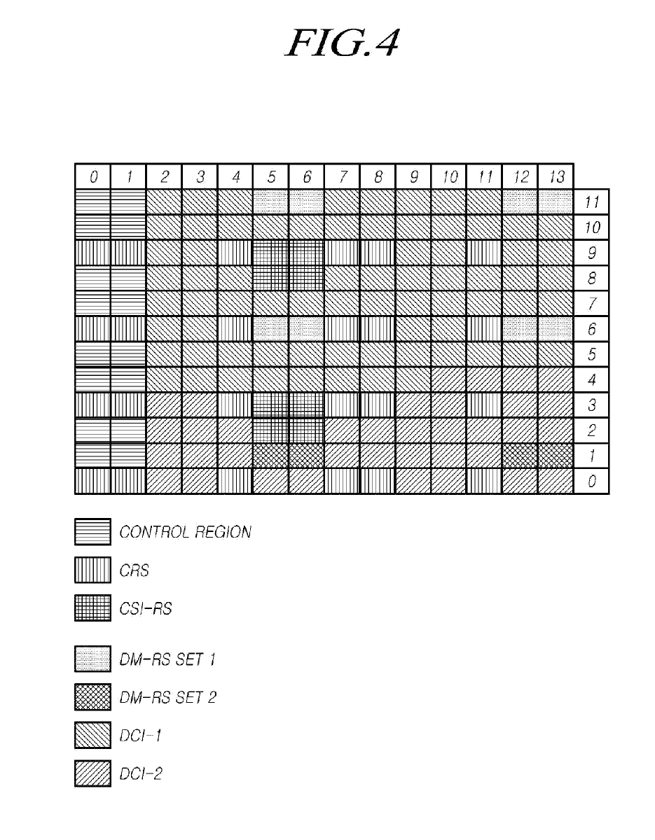

FIG. 4 illustrates a pair of resource blocks to which localization mapping is applied. Referring to FIG. 4, a DCI (DCI-1) for user equipment 1 and a DCI (DCI-2) for user equipment 2 are mapped to the data area (l=2˜11), DM-RS 1 which is a subset of the DM-RS is used for demodulating DCI-1, and DM-RS 2 is used for demodulating DCI-2.

It is possible that an E-CCH and a PDSCH are simultaneously set in a single pair of resource blocks. For example, in the case of the localized mapping, an E-CCH is allocated to a part of a data area and a PDSCH is allocated to another part, and a part of the DM-RS is used for demodulating the E-CCH and another part is used for demodulating the PDSCH.

As described above, an E-PHICH and an E-PDCCH may exist in the E-CCH. Further, when a resource to which a control channel, such as an E-PHICH and/or an E-PDCCH, is allocated and a resource to which a data channel, such as a PDSCH, is allocated are dynamically changed in the data area, a channel for distinguishing the areas may be located in the E-CCH, and the channel may be referred to as an Enhanced Physical Control Format Indicator Channel (E-PCFICH).

When the E-PHICH and the E-PDCCH are mapped, together, to the E-CCH, the E-PHICH is mapped to a resource grid, first, and the E-PDCCH is mapped based on available resource elements remaining after E-PHICH resource mapping. When the E-PCFICH is supported, the E-PHICH may be mapped based on available resource elements remaining after E-PCFICH resource mapping.

Hereinafter, a method of mapping an E-PHICH to a resource element will be described.

Distributed E-PHICH Mapping

Distributed mapping-based transmission operates based on a reference signal, shared in a single group that is formed of a plurality of user equipments and thus, demodulation may be executed using a single reference signal port (for example, a DM-RS port 7 or 8, or a CRS) per group.

A minimum mapping unit for mapping an E-PHICH may be an REG. As described in the case of the PHICH, a single REG is formed of four REs. However, the present invention may not be limited thereto, and an REG (or a minimum mapping unit) differently defined may be used.

The number of available REGs (or REs) that may be used in an E-CCH may be affected by various overhead configurations. Here, the overhead configurations that may be considered herein may include an existing control area, a CSI-RS and/or zero-power CSI-RS setting, a DM-RS setting, a CRS setting, and the like.

In an embodiment, a resource for an E-PHICH may be set in an OFDM symbol, which is not affected by another overhead configuration.

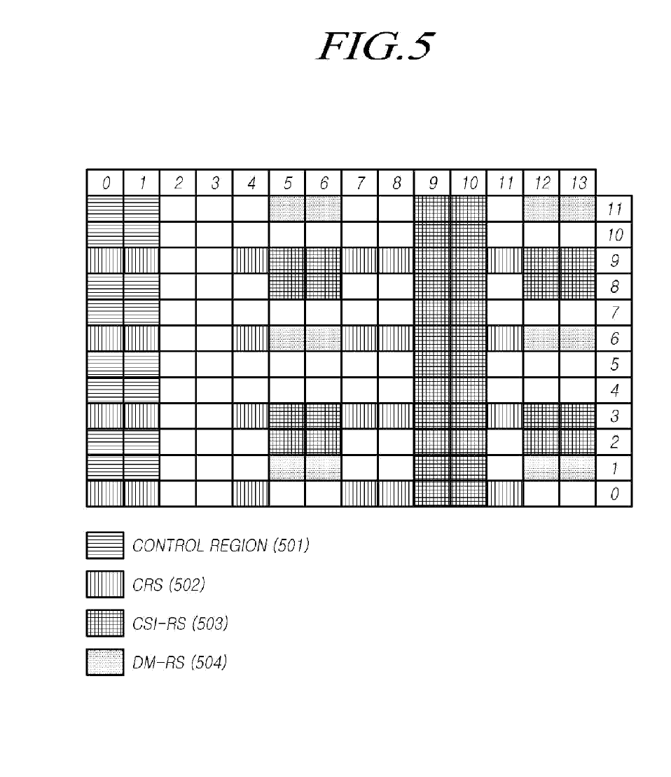

FIG. 5 illustrates a single pair of resource blocks in a normal CP.

Referring to FIG. 5, the diagram 501 indicates a resource allocated for an existing control area. In FIG. 5, although it is illustrated that the existing control area 501 is mapped to first two symbols, the existing control area 501 may be mapped to 0 through 4 symbols. The diagram 502 indicates a resource allocated for a CRS, the diagram 503 indicates a resource allocated for a CSI-RS or a zero-power CSI-RS, and the diagram 504 indicates a resource allocated for a DM-RS.

In the case of a normal CP, an OFDM symbol where an E-PHICH may be located is may be l=0, 1, 2, 3, 4, 7, 8, and 11. A CSI-RS, a zero power CSI-RS, or a DM-RS may be located in an OFDM symbol l=5, 6, 9, 10, 12, and 13, and a size and a location of a resource to which the CSI-RS or the zero-power CSI-RS is allocated may be changed based on the setting and thus, an E-PHICH is not mapped in those OFDM symbols.

In the case of an OFDM symbol l=2 and 3, 12 resource elements are available since another overhead configuration does not exist and thus, three REGs may be set. In the case of an OFDM symbol l=0, 1, 4, 7, 8, and 11, four resource elements may be occupied by a CRS based on a CRS antenna port setting and thus, eight resource elements may be available and thereby two REGs may be set. An OFDM symbol l=0, 1, 2, and 3 may or may not be used for an E-PHICH based on existence and the size of the control area 501.

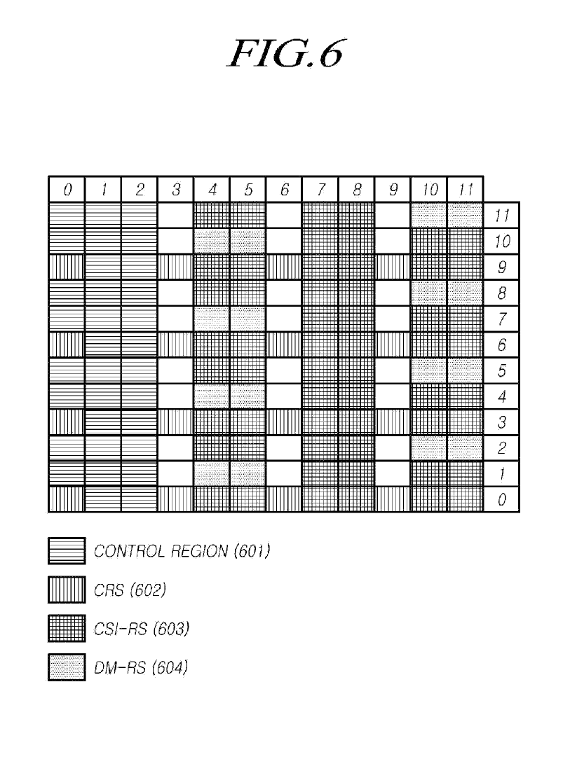

FIG. 6 illustrates a single pair of resource blocks in an extended CP.

Referring to FIG. 6, the diagram 601 indicates a resource allocated for an existing control area. In FIG. 6, although it is illustrated that the existing control area 601 is mapped to first three symbols, the existing control area 601 may be mapped to 0 through 4 symbols. The diagram 602 indicates a resource allocated for a CRS, the diagram 603 indicates a resource allocated for a CSI-RS or a zero-power CSI-RS, and the diagram 604 indicates a resource allocated for a DM-RS.

In the present embodiment, a resource for an E-PHICH may be set in an OFDM symbol, which is not affected by another overhead configuration.

In the case of an extended CP, an OFDM symbol where an E-PHICH may be located may be l=0, 1, 2, 3, 6, and 9. A CSI-RS, a zero power CSI-RS, or a DM-RS may be located in an OFDM symbol l=4, 5, 7, 8, 10, and 11, and a size and a location of a resource to which the CSI-RS or the zero-power CSI-RS is allocated may be changed based on the setting is and thus, an E-PHICH is not mapped in those OFDM symbols since there is no available resource.

In the case of an OFDM symbol l=1 and 2, 12 resource elements are available since another overhead configuration does not exist and thus, three REGs may be set. In the case of an OFDM symbol l=0, 3, 6, and 9, four resource elements may be occupied by a CRS based on a CRS antenna port setting and thus, eight resource elements may be available and thereby two REGs are may be set. An OFDM symbol l=0, 1, 2, and 3 may or may not be used for an E-PHICH based on existence and the size of the control area 601.

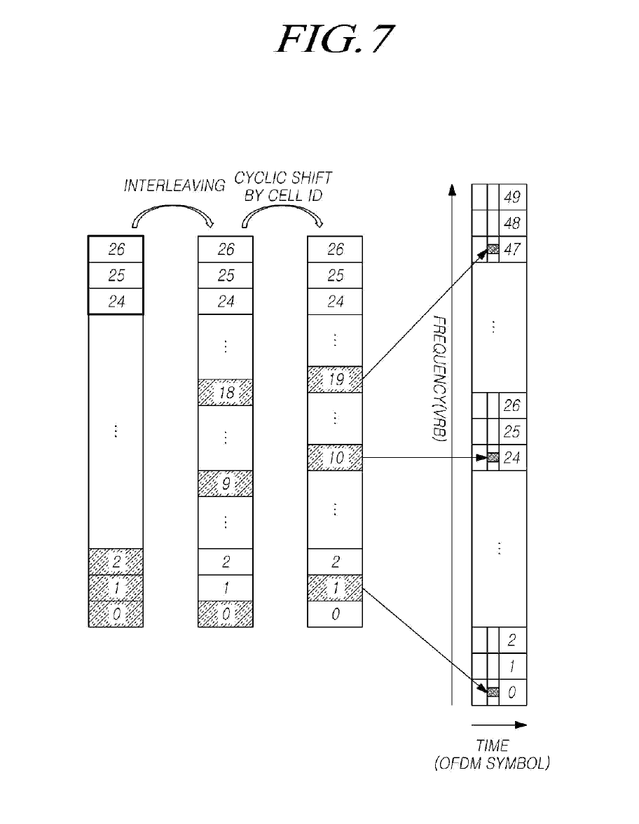

Subsequently, when a plurality of pairs of resource blocks are provided for an E-CCH, and an E-PHICH is transmitted in a predetermined OFDM symbol, and a plurality of REGs are set in a single pair of resource blocks, to which REG of which pair of resource blocks the E-PHICH is mapped will be described with reference to FIG. 7.

The distributed E-PHICH transmission may calculate the number of allocable REGs for each OFDM symbol, set for E-PHICH transmission. For example, when nine pairs of resource blocks are provided for an E-CCH, and three REGs are set in a single pair of resource blocks in the case of a predetermined OFDM symbol to which the E-PHICH is mapped, a total of 27 (=9×3) REGs may be used for E-PHICH transmission.

As described with reference to FIG. 2, the E-PHICH (or PHICH) may be mapped to three REGs. With reference to FIG. 7, the E-PHICH may be mapped to three REGs out of the 27 (0-26) REG resources.

Subsequently, to obtain a frequency diversity gain, the three REGs are mapped at intervals of ⅓ of the total available REG resources, based on an REG index. In FIG. 7, a total of 27 available REG resources exist and thus, an interval between REGs is 9. For example, is when an index of a first REG to which an E-PHICH is mapped is 0, an index of a second REG is 9, and an index of a third REG is 18. The index or an offset of the first REG may be determined based on a cell ID.

The described REG mapping method may be expressed as given in the following Equation 1.

$${\overline{n}}_{i} = \{ \begin{matrix}( {N}_{ID}^{cell} + {m}^{′} ) mod {n}_{{l}_{i}^{′}} & i = 0 \\ ( {N}_{ID}^{cell} + {m}^{′} + ⌊ {n}_{{l}_{i}^{′}} / 3 ⌋ ) mod {n}_{{l}_{i}^{′}} & i = 1 \\ ( {N}_{ID}^{cell} + {m}^{′} + ⌊ 2 {n}_{{l}_{i}^{′}} / 3 ⌋ ) mod {n}_{{l}_{i}^{′}} & i = 2\end{matrix} \qquad [ Equation 1 ]$$

In Equation 1, n̅ᵢ denotes an index of an REG through which each E-PHICH is transmitted, N_{ID}^{cell} denotes a cell ID, m′ denotes an index of an E-PHICH group, and n_{l′}_{ᵢ} denotes the number of REGs available for E-PHICH transmission in an OFDM symbol l′ᵢ. n̅ᵢ has a value of 0 through n_{l′}_{ᵢ}−1.

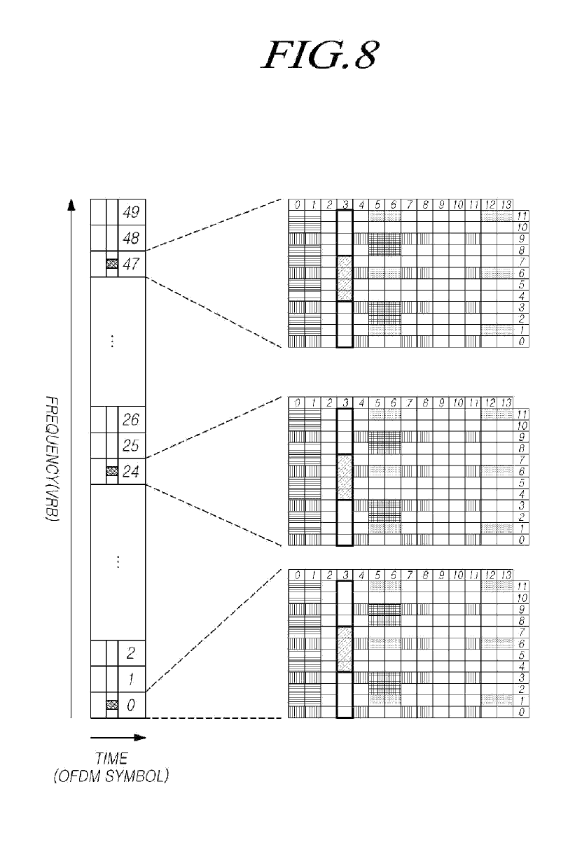

For example, with reference to FIG. 8, it is assumed that a normal CP is used, nine pairs of resource blocks are used for an E-CCH, and an OFDM symbol l′ᵢ in which an E-PHICH is transmitted is 3. In this case, three REGs are available for a single pair of resource blocks and thus, the number of REGs n_{l′}_{ᵢ} available for E-PHICH transmission is 27(=9×3). When N_{ID}^{cell} is 1 and m′ is 0, an index n̅ᵢ of an REG through which each E-PHICH is transmitted is 1, 10, and 19. In this manner, a resource to which an REG is mapped may be determined in a frequency domain.

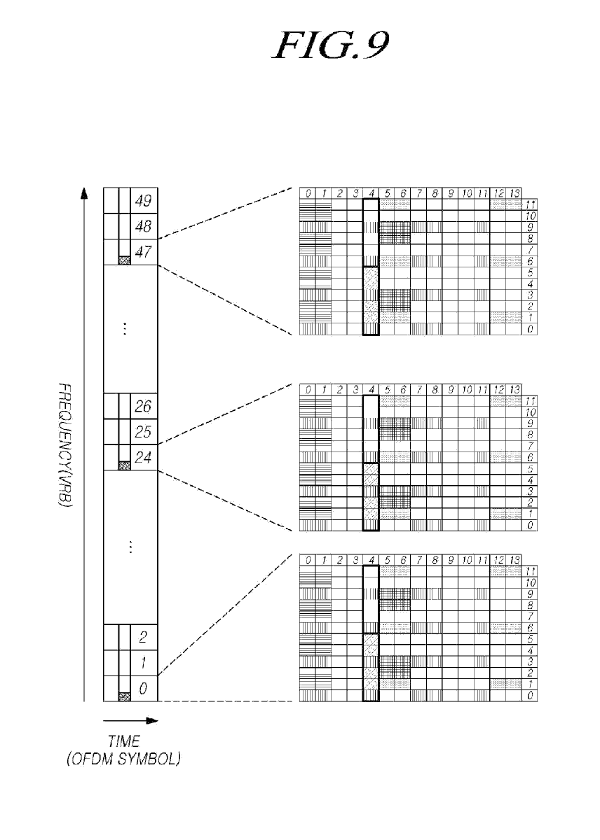

As another example, with reference to FIG. 9, it is assumed that a normal CP is used, nine pairs of resource blocks are used for an E-CCH, and an OFDM symbol l′ᵢ in which an E-PHICH is transmitted is 4. In this case, two REGs are available for a single pair of resource blocks and thus, the number of REGs n_{l′}_{ᵢ} available for E-PHICH transmission is 18(=9×2). When N_{ID}^{cell} is 1 and m′ is 0, an index n̅ᵢ of an REG through which each E-PHICH is transmitted is 1, 7, and 13. In this manner, a resource to which an REG is mapped may be determined in a frequency domain.

An E-PHICH may be transmitted in one or more OFDM symbol resources (time resources). When an E-PHICH is transmitted through a single OFDM symbol, three REGs may be mapped to a single OFDM symbol. When an E-PHICH is transmitted through two OFDM symbols, two REGs are mapped to a single OFDM symbol and a single REG is mapped to the other OFDM symbol, and REGs that are mapped close to each other may be located in different OFDM symbols. When an E-PHICH is transmitted through three OFDM symbols, a single REG may be mapped to each OFDM symbol. When the number of OFDM resources to which an E-PHICH is mapped is 4 or more, an OFDM symbol for a single E-PHICH transmission may be selected by being transferred from a base station to a user equipment through a Radio Resource Control (RRC) signaling or dynamic signaling, or may be determined based on a previously defined rule. As an example of the previously defined rule, three REGs are mapped to OFDM symbol, being maximally spaced apart from one another at regular intervals, since four or more OFDM resources exist.

When an E-PHICH is transmitted through a plurality of OFDM symbols, the number of REGs available for E-PHICH transmission in each OFDM may be different from one another. For example, in the case of the normal CP, when l=3, the number of REGs in a single pair of resource blocks may be set to 3. When l=4, the number of REGs in a single pair of resource blocks may be set to 2. In this case, when Equation 1 is used, REGs to which an E-PHICH is mapped may not be evenly distributed. Accordingly, by taking into consideration the case in which an E-PHICH is transmitted through a plurality of OFDM symbols, Equation 1 may be modulated to Equation 2 as below.

$${\overline{n}}_{i} = \{ \begin{matrix}( ⌊ {N}_{ID}^{cell} \cdot {n}_{{l}_{i}^{′}} / {n}_{{l}_{0 i}^{′}} ⌋ + {m}^{′} ) mod {n}_{{l}_{i}^{′}} & i = 0 \\ ( ⌊ {N}_{ID}^{cell} \cdot {n}_{{l}_{i}^{′}} / {n}_{{l}_{0 i}^{′}} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{cell} \cdot {n}_{{l}_{i}^{′}} / {n}_{{l}_{0 i}^{′}} ⌋ + {m}^{′} + ⌊ 2 {n}_{{l}_{i}^{′}} / 3 ⌋ ) mod {n}_{{l}_{i}^{′}} & i = 2\end{matrix} \qquad [ Equation 2 ]$$

In Equation 2, n̅ᵢ, N_{ID}^{cell}, m′, and n_{l′}_{ᵢ} are identical to those of Equation 1. n_{l′}_{ᵢ} indicates the number of REGs available for E-PHICH transmission in an OFDM symbol l′₀ to which a first REG (i=0) is mapped.

For example, when the normal CP is used, nine pairs of resource blocks are used for an E-CCH, an OFDM symbol l′ᵢ in which an E-PHICH is transmitted is 3 and 4, and a first (i=0) REG and a third (i=2) REG, through which an E-PHICH is transmitted, is transmitted through an OFDM symbol l′ᵢ and a second (i=1) REG is transmitted through an OFDM symbol l′ᵢ 4. When the OFDM symbol l′ᵢ is 3, three REGs may be available for a single pair of resource blocks and thus, the number of REGs n_{l′}_{ᵢ} available for the E-PHICH transmission may be 27(=9×3). When the OFDM symbol l′ᵢ is 4, two REGs may be available for a single pair of resource blocks and thus, the number of REGs n_{l′}_{ᵢ} available for the E-PHICH transmission may be 18(=9×2).

In an embodiment, an index of an OFDM symbol for E-PHICH transmission may be determined based on a size of a control area. A maximum number of available OFDM symbols may be 3. For example, when a single OFDM symbol (l=0) is allocated for a control area, a maximum of three OFDM symbols (l=3,2,1) may be used for E-PHICH transmission. When a single OFDM symbol is set to be an E-PHICH transmission symbol, an E-PHICH may be mapped based on a single OFDM symbol (for example, l=3). When two OFDM symbols are set to be E-PHICH transmission symbols, an E-PHICH may be mapped based on the two OFDM symbols (for example, l=3,2).

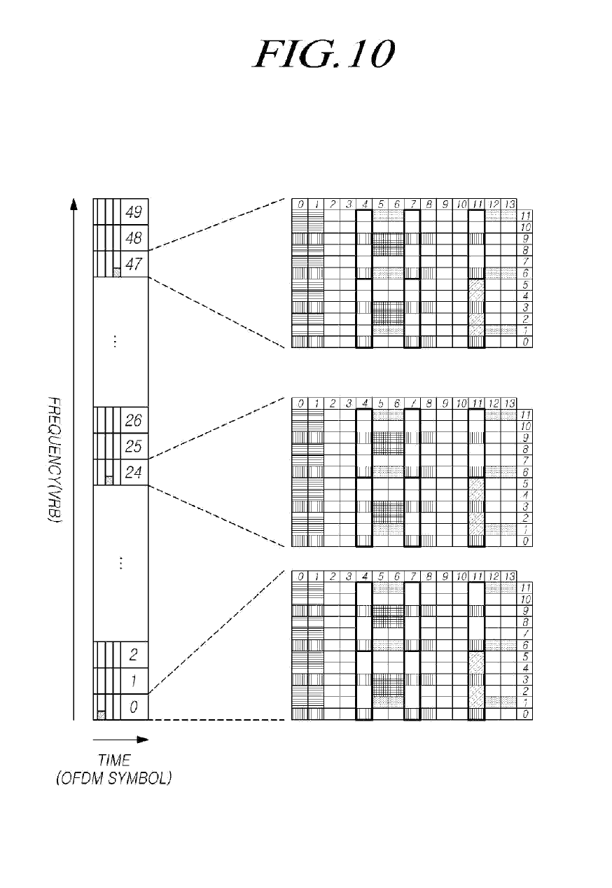

In another example, an index of an OFDM symbol for E-PHICH transmission may be determined, irrespective of a size of a control area. A maximum size of the control area is may be three symbols (the case in which the size of the control area is four symbols is exceptional. That is, only when the number of transmission resource blocks is less than 10, the size of the control area may be 4 symbols). Accordingly, in the case of the normal CP, the OFDM symbol for E-PHICH transmission may be selected from l=3,4,7,8, and 11, and in the case of the extended CP, the OFDM symbol for E-PHICH transmission may be selected from l=3,6, and 9. When a single OFDM symbol is set to be an E-PHICH transmission symbol, an E-PHICH may be mapped based on one of the described symbols. When two OFDM symbols are set to be E-PHICH transmission symbols, an E-PHICH may be mapped based on two of the described symbols. When three OFDM symbols are set to be E-PHICH transmission symbols, an E-PHICH may be mapped based on three of the described symbols. For example, with reference to FIG. 10, when three OFDM symbols are set to be E-PHICH transmission symbols, an E-PHICH may be mapped based on three OFDM symbols (for example, l=4,7, and 11).

When the number of OFDM symbols allocated for the control area is changed, the index of the OFDM symbol for the E-PHICH transmission may be changed.

In an embodiment, resources for the E-PHICH may be determined based on all available REGs.

An incontiguous or contiguous resource allocation method may be used based on an existing Resource Block Group (RBG) or Resource Block (RB) unit, so as to set a distributed control area to which an E-CCH is designated.

The number of available REGs, which may be mapped to each Virtual Resource Block (VRB) in an allocated E-CCH area, may be calculated based on the current setting. A is setting that may affect the number of available REGs may be a CRS antenna configuration, a DM-RS and CSI-RS setting, a normal CP or extended CP, and a control area. The number of REGs that may be used in a single pair of resource blocks by taking into consideration the settings may be arranged as shown in Table 1.

TABLE 1

| | OFDM | | | | UE-RS CDM | REG(s)/ |
|---|---|---|---|---|---|---|
| Configuration | Symbols for legacy | CP | CRS | CSI-RS | group | VRB Pair |
| 0 | 2 | Normal | 2 | 4 | 1 | 29 |
| 1 | | | 4 | 4 | 1 | 28 |
| 2 | | | 2 | 8 | 1 | 28 |
| 3 | | | 4 | 8 | 1 | 27 |
| 4 | | Extended | 2 | 4 | 1 | 22 |
| 5 | | | 4 | 4 | 1 | 21 |
| 6 | | | 2 | 8 | 1 | 21 |
| 7 | | | 4 | 8 | 1 | 20 |
| 8 | 3 | Normal | 2 | 4 | 1 | 26 |
| 9 | | | 4 | 4 | 1 | 25 |
| 10 | | | 2 | 8 | 1 | 25 |
| 11 | | | 4 | 8 | 1 | 24 |
| 12 | | Extended | 2 | 4 | 1 | 19 |
| 13 | | | 4 | 4 | 1 | 18 |
| 14 | | | 2 | 8 | 1 | 18 |
| 15 | | | 4 | 8 | 1 | 17 |
| 16 | 1 | Normal | 2 | 4 | 1 | 32 |
| 17 | | | 4 | 4 | 1 | 31 |
| 18 | | | 2 | 8 | 1 | 31 |
| 19 | | | 4 | 8 | 1 | 30 |
| 20 | | Extended | 2 | 4 | 1 | 22 |
| 21 | | | 4 | 4 | 1 | 21 |
| 22 | | | 2 | 8 | 1 | 21 |
| 23 | | | 4 | 8 | 1 | 20 |

For example, according to the configuration 3, two OFDM symbols are allocated for a control area, and a normal CP is used, the number of CRS antenna ports is 4, the number of CSI-RS antenna ports is 8, and a Code Division Multiplexing (CDM) group of a DM-RS (UE-RS) is 1, 27 available REGs may exist in a single pair of virtual resource blocks.

The total number of available REGs may be calculated based on the number of distributed control areas set based on a resource block group or a resource block unit and the number of available REGs in a single pair of virtual resource blocks.

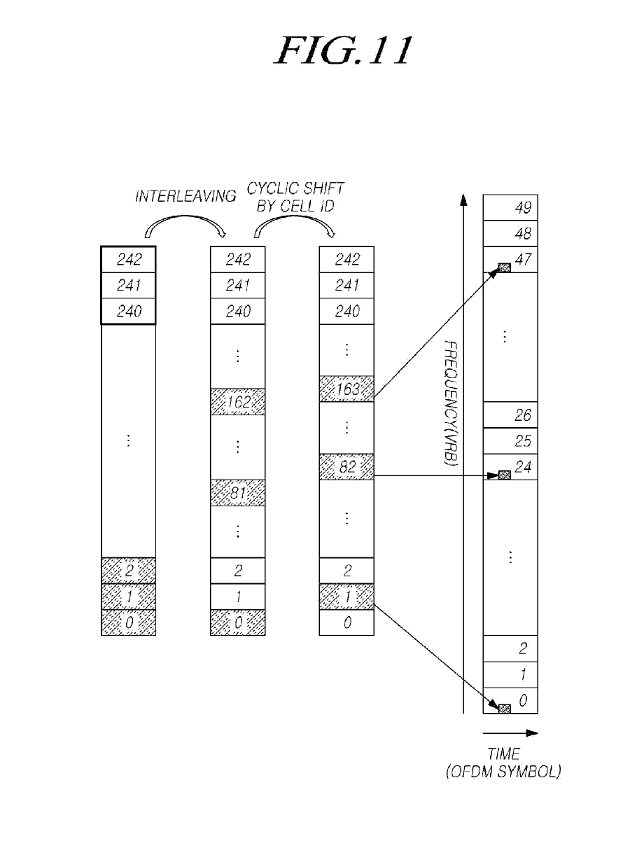

FIG. 11 illustrates the case in which nine pairs of resource blocks are used as distributed control areas, and 27 available REGs (Configuration 3) exist in a single pair of resource blocks and thus, a total of 243(=27×9) available REGs exist.

Three REGs form a single PHICH group for distributed mapping in the E-CCH. As described above, a total of 8 PHICHs form a single PHICH group through repetitive coding three times and spreading as orthogonal sequence of 4.

To obtain a frequency diversity gain in the set E-CC area, the entire E-CCH area is interleaved with REGs forming a single E-PHICH group. The REGs that are processed through interleaving to obtain randomization effect that avoids inter-cell interference may be cyclic-shifted based on a cell ID.

Referring to FIG. 11, three REGs (0, 1, and 2) form a single PHICH group, and is may be mapped to three virtual REGs (1, 82, and 163) through interleaving and cyclic shift.

The above described process may be expressed through Equation 3.

$${\overline{n}}_{i} = \{ \begin{matrix}{n}^{′} mod {N}_{E - PHICH}^{REG} & i = 0 \\ ( {n}^{′} + ⌊ {N}_{E - PHICH}^{REG} / 3 ⌋ ) mod {N}_{E - PHICH}^{REG} & i = 1 \\ ( {n}^{′} + 2 \cdot ⌊ {N}_{E - PHICH}^{REG} / 3 ⌋ ) mod {N}_{E - PHICH}^{REG} & i = 2\end{matrix} \\ {n}^{′} = {N}_{ID}^{cell} + n \qquad [ Equation 3 ]$$

In Equation 3, N_{E-PHICH}^{REG} is the total number of available REGs, N_{ID}^{cell} is a cell ID, and n is an index of an E-PHICH group.

The REGs finally determined as described above may be mapped to an actual physical resource block domain.

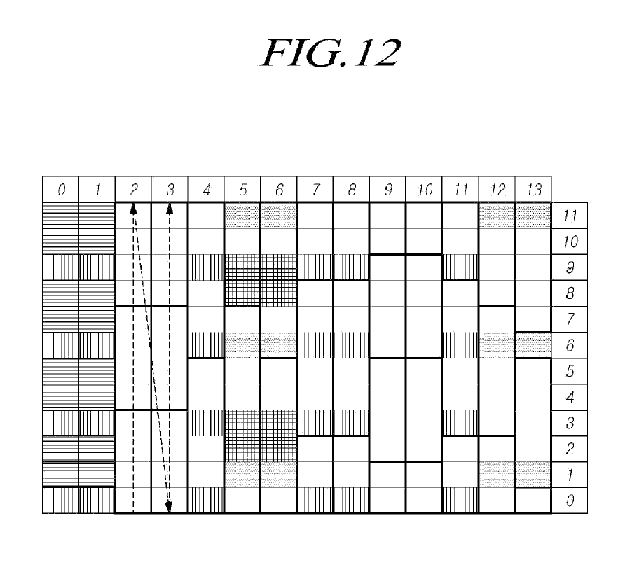

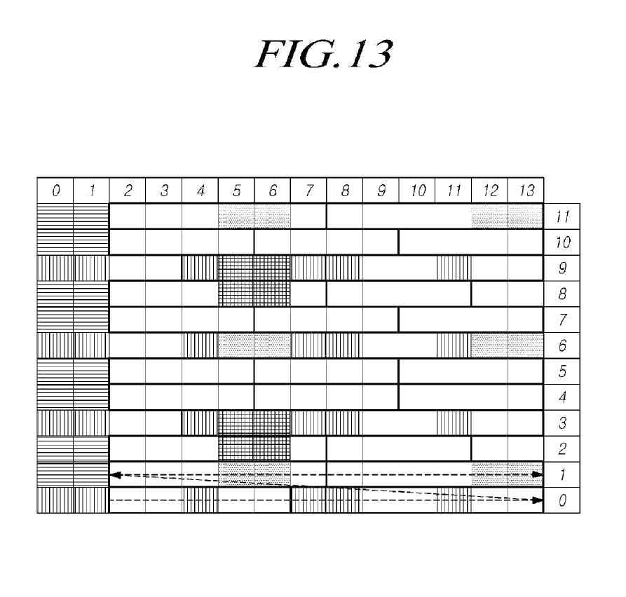

As shown in FIG. 12, the numbering of the REGs in a pair of physical resource blocks is in ascending order from a low frequency index to a high frequency index, and then, from a low OFDM symbol index to a high OFDM symbol index. Alternatively, as shown in FIG. 13, the numbering is in ascending order from a low OFDM symbol index to a high OFDM symbol index, and then, from a low frequency index to a high frequency index.

Alternatively, as described above, mapped REGs are distributed in each pair of resource blocks through additional interleaving so that the randomization effect may increase.

Localized E-PHICH Mapping

A localized E-PHICH may be mapped to an area set to be a localized E-CCH area, together with an E-PDCCH. In the area, the E-PHICH is mapped to a resource grid and is the E-PDCCH is mapped to the remaining resources.

The localized E-CCH and the distributed E-CCH may be multiplexed with a pair of physical resource blocks as a unit, based on Frequency Division Multiplexing (FDM). The localized E-CCH and the distributed E-CCH may be multiplexed in an identical pair of resource blocks, based on an FDM or a TDM.

A transmission scheme using the localized mapping (for example, beamforming or Multi User Multiple Input Multiple Output (MU-MIMO)) may operate based on an accurate Channel Status Information (CSI) feedback environment. In a single pair of resource blocks, control signals of which the number corresponds to the number of supported orthogonal DM-RS resources may be transmitted. That is, a single DM-RS port is associated with transmission of a single E-PHICH or E-PDCCH. Accordingly, the use of the DM-RS port resources, which is associated with the localized E-PHICH transmission, may affect the capacity of E-PDCCH transmission. The localized E-PHICH setting (and localized E-PDCCH setting) may be transferred from a base station to a user equipment through a signaling specified to the user equipment.

The transmission scheme using the localized mapping may be a scheme that may obtain a gain that is more enhanced by beamforming or MU-MIMO transmission, through accurate channel feedback information transmitted to a set user equipment. The E-CCH allocates an independent DM-RS port resource to each E-PHICH or E-PDCCH transmission, utilizes a DM-RS port resource, which is precoded, being specified to the user equipment, and supports the above described beamforming or MIMO transmission method.

Accordingly, the E-PHICH may be transmitted through a predetermined pair of is resource blocks through which a related DM-RS is transmitted together, using the localized mapping. Further, consecutive REG indices included in a single PHICH group may be sequentially allocated to a physical resource block domain.

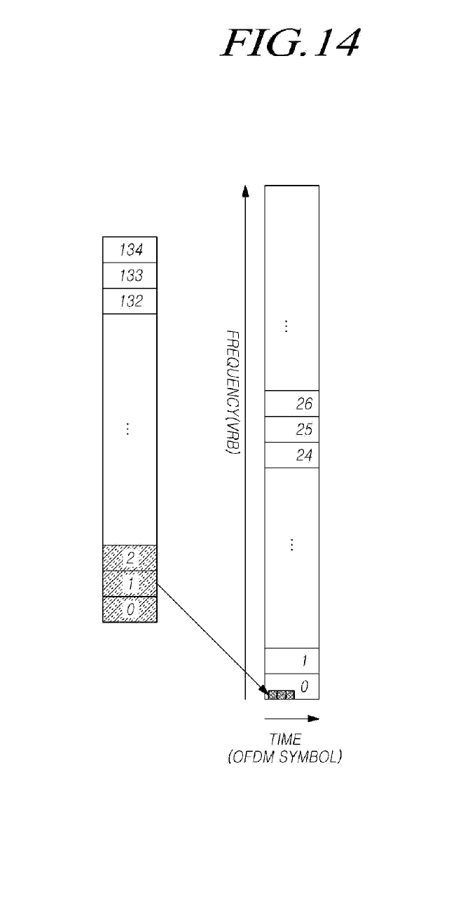

FIG. 14 illustrates an example of a localized mapping method. Referring to FIG. 14, the total number of available REGs may be determined based on the number of REGs available in a single pair of resource blocks. For example, when 5 pairs of resource blocks are provided for localized mapping and 27 REGs are available for a single pair of resource blocks, a total of 135(=5×27) REGs are usable. Consecutive REG indices included in a single PHICH group may be contiguously allocated in the single pair of resource blocks. The numbering of the REGs in a pair of physical resource blocks is in ascendant order from a low frequency index to a high frequency index, and then, from a low OFDM symbol index to a high OFDM symbol index. Alternatively, the numbering is in ascending order from a low OFDM symbol index to a high OFDM symbol index, and then, from a low frequency index to a high frequency index.

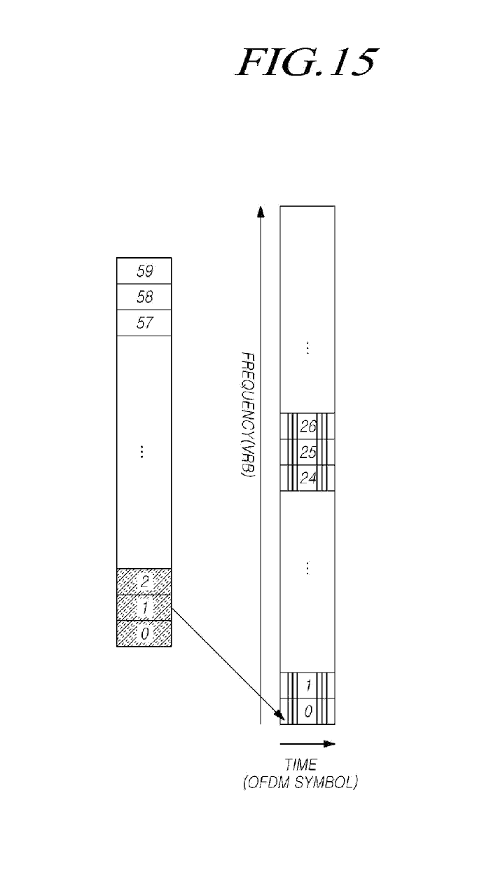

FIG. 15 illustrates another example of a localized mapping method. Referring to FIG. 15, an E-PHICH is transmitted through only a predetermined OFDM symbol, and the total number of available REGs may be determined using the above. For example, when five pairs of resource blocks are provided for localized mapping, an E-PHICH is transmitted through only 4 OFDM symbols, and three REGs are allocated to a single OFDM symbol, a total of 60(=5×4×3) REGs may be usable. Consecutive REG indices included in a single PHICH group may be contiguously allocated in the single pair of resource blocks.

Although the embodiments of the present invention have been described for illustrative purposes, those skilled in the art will appreciate that various modifications, additions and substitutions are possible, without departing from the scope and spirit of the invention. Accordingly, the embodiments disclosed in the present invention are only for describing, but not limiting, the technical idea of the present invention, and the scope of the technical idea of the present invention is not limited by the embodiments. The scope of the present invention shall be construed on the basis of the accompanying claims in such a manner that all of the technical ideas included within the scope equivalent to the claims belong to the present invention.

1. A method of mapping a hybrid Automatic Repeat reQuest (ARQ) indication channel based on a resource element unit, the method comprising:
setting, in a data area through which downlink data is transmitted, resource blocks where an Enhanced Physical Downlink Control CHannel (E-PDCCH) is set;
determining an index of a resource element group through which the hybrid ARQ indication channel is transmitted, based on the total number of available resource element groups of an E-PDCCH in the set resource blocks; and
mapping the hybrid ARQ indication channel to a resource element, based on the determined index.

2. The method as claimed in claim 1, wherein the resource element group is located in a predetermined Orthogonal Frequency Division Multiplexing (OFDM) symbol.

3. The method as claimed in claim 2, wherein, when a plurality of OFDM symbols, where the resource element group is located, exists, and the number of resource element groups located in each OFDM symbol is different from each other, determining the index comprises:
determining the index of the resource element group, based on a ratio of the number of resource element groups available in a symbol in which the hybrid ARQ indication channel is transmitted and the number of resource element groups available in a symbol in which a first resource element group is transmitted.

4. The method as claimed in claim 2, wherein determining the index comprises:
determining the index of the resource element group (REG) based on the following equation:
$${\overline{n}}_{i} = \{ \begin{matrix}( ⌊ {N}_{ID}^{cell} \cdot {n}_{{l}_{i}^{′}} / {n}_{{l}_{0 i}^{′}} ⌋ + {m}^{′} ) mod {n}_{{l}_{i}^{′}} & i = 0 \\ ( ⌊ {N}_{ID}^{cell} \cdot {n}_{{l}_{i}^{′}} / {n}_{{l}_{0 i}^{′}} ⌋ + {m}^{′} + ⌊ {n}_{{l}_{i}^{′}} / 3 ⌋ ) mod {n}_{{l}_{i}^{′}} & i = 1 \\ ( ⌊ {N}_{ID}^{cell} \cdot {n}_{{l}_{i}^{′}} / {n}_{{l}_{0 i}^{′}} ⌋ + {m}^{′} + ⌊ 2 {n}_{{l}_{i}^{′}} / 3 ⌋ ) mod {n}_{{l}_{i}^{′}} & i = 2\end{matrix} ,$$
wherein n̅ᵢ denotes an index of a resource element group through which each hybrid ARQ indication channel is transmitted, N_{ID}^{cell} ID denotes a cell ID, m′ denotes an index of each hybrid ARQ indication channel group, and n_{l′}_{ᵢ} denotes the number of REGs usable for Enhanced Physical Hybrid ARQ Indicator CHannel (E-PHICH) transmission in an OFDM symbol l′ᵢ, which is obtained through a product of the number of resource blocks to which an E-PDCCH is set, and 2 or 3.

5. The method as claimed in claim 1, wherein the resource element group is located in an entire extended control channel, excluding a resource to which a reference signal is set.

6. The method as claimed in claim 5, wherein determining the index comprises:
determining the index of the resource element group (REG) based on the following Equation:
$${\overline{n}}_{i} = \{ \begin{matrix}{n}^{′} mod {N}_{E - PHICH}^{REG} & i = 0 \\ ( {n}^{′} + ⌊ {N}_{E - PHICH}^{REG} / 3 ⌋ ) mod {N}_{E - PHICH}^{REG} & i = 1 \\ ( {n}^{′} + 2 \cdot ⌊ {N}_{E - PHICH}^{REG} / 3 ⌋ ) mod {N}_{E - PHICH}^{REG} & i = 2\end{matrix} \\ {n}^{′} = {N}_{ID}^{cell} + n ,$$
wherein n̅ᵢ denotes an index of a resource element group through which each hybrid ARQ indication channel is transmitted, N_{E-PHICH}^{REG} denotes the total number of available resource element groups of the E-PDCCH in the set resource blocks, N_{ID}^{cell} denotes a cell ID, and n denotes an index of each hybrid ARQ indication channel group.

7. The method as claimed in claim 1, wherein an index of each resource element group included in an identical hybrid ARQ indication channel group is distributed, being spaced apart at regular intervals.

8. The method as claimed in claim 1, wherein an index of each resource element group included in an identical hybrid ARQ indication channel group is contiguously distributed.

9. The method as claimed in claim 6, wherein the total number of available resource element groups of the E-PDCCH in the set resource blocks is determined based on a Cell-specific Reference Signal (CRS) antenna configuration, a Demodulation Reference Signal (DM-RS) and Channel State Information Reference Signal (CSI-RS) setting, a normal Cyclic Prefix (CP) or extended CP, and a control area.
